(19) United States
(12) Patent Application Publication
(10) Pub. No.: US 2018/0347763 A1
(43) Pub. Date: Dec. 6, 2018

(54) MACHINE LEARNING DETECTION OF PIPELINE RUPTURES

(71) Applicant: Schneider Electric Software, LLC, Foxboro, MA (US)

(72) Inventors: Matthew Howard Ford, Catonsville, MD (US); Sarah Elizabeth Williams, Baltimore, MD (US); Feili Huang, Columbia, MD (US); Joshua Allen Brown, Baltimore, MD (US)

(73) Assignee: Schneider Electric Software, LLC, Foxboro, MA (US)

(21) Appl. No.: 15/610,025

(22) Filed: May 31, 2017

(51) Int. Cl. F17D 5/06; G06N 3/08; G06N 3/10

(52) U.S. Cl. CPC F17D 5/06; G06N 3/10; G06N 3/08

(57) ABSTRACT

Automated detection of pipeline ruptures using machine learning techniques. A plurality of independent rupture detection techniques each generate a status determination indicative of whether the pipeline is ruptured. A combiner utilizing a neural network algorithm analyzes the status determinations to generate a single, high-confidence status determination indicative of whether the pipeline is ruptured.

### TECHNICAL FIELD

Aspects of the present disclosure generally relate to the fields of networked computerized industrial control, automation systems, networked computerized systems utilized to monitor, log, and display relevant manufacturing/production events and associated data, and supervisory level control and manufacturing systems. More particularly, aspects relate to systems and methods that detect pipeline ruptures in real-time.

### BACKGROUND

Typical industrial processes are extremely complex and generate substantially greater volumes of information than any human could possibly digest in its raw form. By way of example, it is not unheard of to have thousands of sensors and control elements (e.g., valve actuators) monitoring/controlling aspects of a multi-stage process within an industrial process. These sensors are of varied type and report on varied characteristics of the process. Their outputs are similarly varied in the meaning of their measurements, in the amount of data sent for each measurement, and in the frequency of their measurements. As regards the latter, for accuracy and to enable quick response, some of these sensors/control elements take one or more measurements every second.

Operators of industrial processes that include pipelines require monitoring systems that detect pipeline ruptures (e.g., a leak of greater than 50% rated flow, etc.) with high confidence to mitigate desensitization from false alarms, mitigate lost productivity from unnecessary shutdowns, and reduce the amount of fluid lost during rupture conditions, for example. Moreover, industry best practices emphasize the importance of implementing rupture detection techniques separately from small-volume leak detection techniques to account for the specific impacts of pipeline ruptures. Known monitoring systems each rely on a single detection method, which results in an undesirable number of false alarms for operators and/or an undesirable amount of time delay (e.g., more than one minute, etc.) before a high-confidence rupture determination is generated. Known monitoring systems that have attempted to combine more than one detection method utilize algorithms that each covers only a subset of rupture scenarios. Thus, these systems still rely on the results a single detection method because the algorithms are complementary to each other and result in an undesirable number of false alarms.

### SUMMARY

Aspects of the disclosure rapidly detect pipeline ruptures based on a plurality of independent rupture detection techniques whose outputs are analyzed with a neural network algorithm to generate a single, high-confidence status determination indicative of whether the pipeline is ruptured.

In an aspect, a pipeline rupture detection system includes a display device, a processor, and at least one computer-readable storage medium storing one or more processor-executable instructions. Included in the instructions are a support vector machine, a third-law engine, a rate of change combination engine, and a neural network combiner. The support vector machine is configured to analyze input data with a supervised machine learning algorithm and generate a first status determination indicative of whether a pipeline is ruptured based on the analysis. The input data represents one or more physical properties of the pipeline. The third-law engine is configured to analyze the input data for pressure changes in the pipeline relative to operating state changes of the pipeline represented by the input data. Based on the analysis, the third-law engine is configured to generate a second status determination indicative of whether the pipeline is ruptured. The rate of change combination engine is configured to analyze the input data for changes to the physical properties of the pipeline occurring at rates that exceed predetermined physical limits of the pipeline and generate a third status determination indicative of whether the pipeline is ruptured based on the analysis. The neural network combiner is configured to execute a neural network algorithm on the first status determination, the second status determination, and the third status determination. Based on executing this algorithm, the neural network combiner generates a final status determination on the display device indicative of whether the pipeline is ruptured.

In another aspect, a computer-implemented method for detecting pipeline ruptures with high confidence includes receiving pipeline data from a supervisory control and data acquisition system. The pipeline data represents physical properties of a pipeline. A support vector machine generates a first status determination indicative of whether the pipeline is ruptured by analyzing the pipeline data with a supervised machine learning algorithm. A third-law engine generates a second status determination indicative of whether the pipeline is ruptured by comparing pressure changes in the pipeline to operating state changes of the pipeline. A rate of change combination engine generates a third status determination indicative of whether the pipeline is ruptured by analyzing the pipeline data for changes to the physical properties occurring at rates that exceed predetermined physical limits of the pipeline. A neural network combiner generates a final status determination on a display device that is indicative of whether the pipeline is ruptured. The neural network generates the determination by analyzing the first, second, and third status determinations with a neural network algorithm.

In yet another aspect, a computer readable storage device stores processor readable instructions that, when executed by a processor, implement a method of automatically detecting pipeline ruptures. The method includes receiving pipeline data from a supervisory control and data acquisition system that represents physical properties of a pipeline. A support vector machine generates a first status determination indicative of whether the pipeline is ruptured by analyzing the pipeline data with a supervised machine learning algorithm. A third-law engine generates a second status determination indicative of whether the pipeline is ruptured by comparing pressure changes in the pipeline to operating state changes of the pipeline. A rate of change combination engine generates a third status determination indicative of whether the pipeline is ruptured by analyzing the pipeline data for changes to the physical properties occurring at rates that exceed predetermined physical limits of the pipeline. A neural network combiner generates a final status determination on a display device that is indicative of whether the pipeline is ruptured. The neural network generates the determination by analyzing the first, second, and third status determinations with a neural network algorithm.

Other objects and features will be in part apparent and in part pointed out hereinafter.

### BRIEF DESCRIPTION OF THE DRAWINGS

FIG. 1 is a block diagram illustrating pipeline rupture detection system and process according to an embodiment.

FIGS. 2 and 3 are block diagrams illustrating exemplary historical data processing engines and processes according to an embodiment.

FIGS. 4 and 5 are block diagrams illustrating exemplary supervised learning methods of a support vector machine according to an embodiment.

FIG. 6 is a block diagram illustrating an exemplary process of a third-law engine according to an embodiment.

FIG. 7 is a block diagram illustrating an exemplary process of setting up a rate of change combination engine according to an embodiment.

FIG. 8 is a block diagram illustrating an exemplary process of training a neural network combiner according to an embodiment.

FIG. 9 illustrates an exemplary industrial process system within which aspects of the disclosure is incorporated according to an embodiment.

FIG. 10 is a block diagram of an exemplary computing device architecture within which aspects of the disclosure is implemented according to an embodiment.

Corresponding reference characters indicate corresponding parts throughout the drawings.

### DETAILED DESCRIPTION

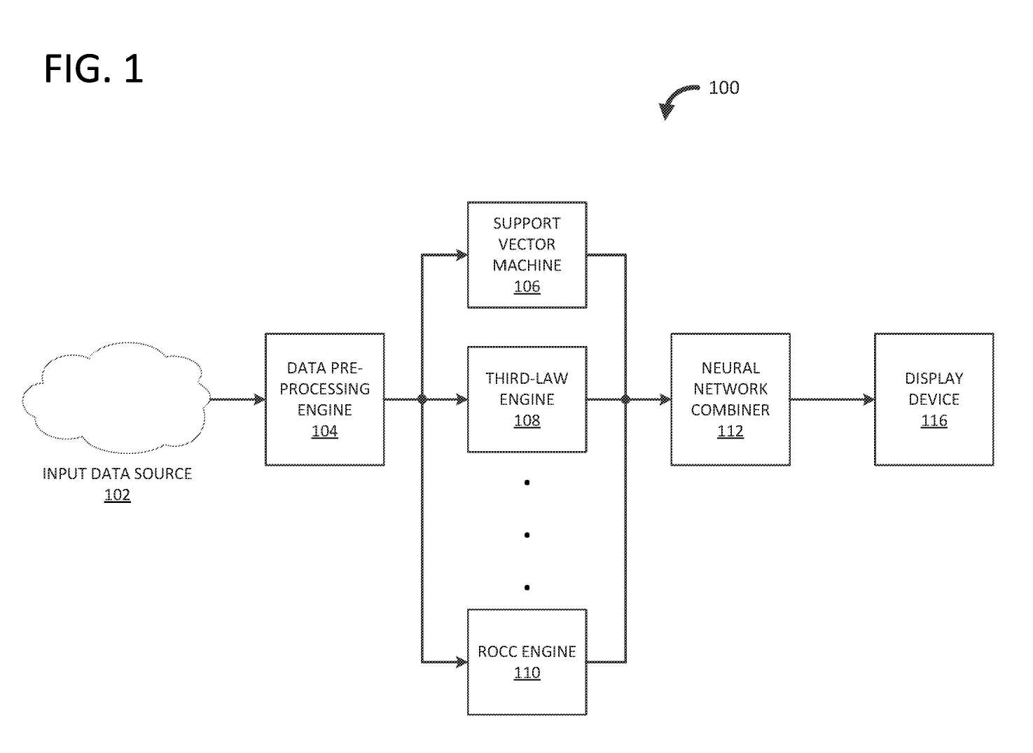

FIG. 1 illustrates an exemplary pipeline rupture detection system and process, generally indicated at 100, configured to detect pipeline ruptures and generate a display indicating the status of the pipeline (e.g., “rupture” or “no rupture”) in accordance with an embodiment of the disclosure. The system includes an input data source 102, a data pre-processing engine 104, a support vector machine 106, a third-law engine 108, a rate of change combination (ROCC) engine 110, a neural network combiner 112, and a display device 116. In an embodiment, the neural network combiner 112 includes one or more hidden layers. In an embodiment, the support vector machine 106, the third-law engine 108, and the ROCC engine 110 independently analyze input data from pre-processing engine 104 to each generate a status determination indicative of whether the pipeline is ruptured. Although the embodiment illustrated in FIG. 1 includes three rupture detection techniques, one of ordinary skill in the art will understand that additional independent rupture detection techniques may be added within the scope of the disclosure.

The input data source 102 is configured to store and provide data representative of physical properties of the pipeline. In an embodiment, input data source 102 is a supervisory control and data acquisition (SCADA) system with local data storage. In another embodiment, input data source 102 is a SCADA system with cloud-based data storage. An exemplary SCADA system includes OASyS SCADA available from Schneider Electric. The data pre-processing engine 104 is configured to process and format data received from input data source 102. In an embodiment, data pre-processing engine 104 processes and formats received data by re-sampling and/or smoothing the data, as further described herein. Once data pre-processing engine 104 includes enough pipeline data to fill a window of predetermined time (e.g., five minutes), the data chunk stored in data pre-processing engine 104 is fed to support vector machine 106, third-law engine 108, and ROCC engine 110. The pipeline rupture detection system 100 runs each time pipeline data is received from input data source 102. In an exemplary embodiment, system 100 runs every five seconds and during each run data pre-processing engine 104 stores pipeline data from the previous five minutes as the signal it is processing. In this manner, system and process 100 detects pipeline ruptures in real time.

The support vector machine 106 is trained from a dataset of known operating conditions from previous pipeline operation and a dataset of abnormal operating conditions of the pipeline that support vector machine 106 autonomously recognizes, as further described herein. After it is trained, support vector machine 106 is configured to receive data from pre-processing engine 104 in real-time during an online operation and generate a status determination indicative of whether the pipeline is in a safe operating state or whether a rupture has occurred. In an embodiment, the status determination generated by support vector machine 106 is a numerical value to the probability of a signal being indicative of a pipeline rupture.

The third-law engine 108 is configured to receive data from pre-processing engine 104 and monitor the data for a pressure drop at any pressure transmitter along the pipeline in real-time during an online operation. When it detects a pressure drop, third-law engine 108 looks at inputs to the pipeline to determine whether the pressure drop corresponds to a change in one of the relevant inputs within a relevant time period. In an embodiment, third-law engine 108 operates under the assumption that a pipeline at rest will stay at rest unless an input changes. The third-law engine 108 includes a listing of outputs (e.g., pressure transmitters and their respective locations) and a listing of inputs (e.g., pump statuses, VFD speeds, CV positions, injection/delivery flows, valve statuses, etc.) of the pipeline. The third-law engine 108 is also configured to generate a status determination indicative of whether the pipeline is ruptured. In accordance with an aspect of the disclosure, third-law engine 108 does not need to be trained. The third-law engine 108 includes an extensible component to enable a user to add one or more processor-executable instructions (e.g., code) for extra functionality in one or more embodiments. Aspects of the user extensibility and offline testing of third-law engine 108 are further described herein.

In an embodiment, third-law engine 108 includes a pressure loss (PLOSS) technique component. To avoid falsely identifying known events, the PLOSS technique is combined with monitoring control surfaces (e.g., equipment states) on the pipeline upstream and/or downstream of the pressure sensors. This combined technique (referred to as a third law analysis in an embodiment) assumes that a pressure change in the pipeline is the result of an operating state change and that a rupture is a pressure change in the absence of any operating state change. The third-law engine 108 utilizes a Heaviside function, X, that determines whether a significant control surface change has occurred at location i. For example, if data from location i is anomalous, third-law engine 108 looks back up and/or down the pipeline (e.g., location i-1, i-2, etc.) to determine what may have caused the anomalous data. In an embodiment, third-law engine 108 operates in accordance with the following equation:

$$Λ = {\sum }_{i = start}^{end} {λ}_{i}$$

with the following cases:

$$λ = \{ \begin{matrix}0 \text{:} Δ nsp \leq T ; Δ {Cv}_{pos} \leq S ; Δ v / {v}_{status} = 0 ; Δ F \leq Δ F ; Δ {pump}_{status} = 0 \\ 1 \text{:} Δ nsp > T ; Δ {Cv}_{pos} > S ; Δ v / {v}_{status} \neq 0 ; Δ F > Δ F ; Δ {pump}_{status} \neq 0\end{matrix}$$

where T is the VFD speed change, S is the control valve position change, and δF is the flow rate change. When a pressure loss event is indicated and Λ=0 then third-law engine 108 detects a potential pipeline rupture. In an embodiment, the status determination generated by third-law engine 108 includes a three-tier classification scheme (e.g., HIGH, MEDIUM, LOW). In an aspect, when third-law engine 108 detects a pressure drop, the pressure readings are cross-correlated with operational information of the pipeline to reduce the number of false alarms. For instance, when third-law engine 108 detects a pressure drop with no corresponding control change and a change in flow, third-law engine 108 indicates a high probability of a pipeline rupture. When a control event occurs within the time needed for a pressure wave to travel to a station, third-law engine 108 indicates a low probability of a pipeline rupture. In an embodiment, a station is a location on the pipeline where one or more pieces of equipment (e.g., pump stations, etc.) reside and are classified as a single grouping within the SCADA system. When the probability is neither high nor low, third-law engine 108 indicates a medium probability of a pipeline rupture.

Still referring to FIG. 1, ROCC engine 110 is configured to receive data from pre-processing engine 104 and analyze the received data for physical changes to the pipeline occurring at rates that exceed predetermined physical limits of the pipeline in real-time during an online operation. The ROCC engine 110 is also configured to generate a status determination indicative of whether the pipeline is ruptured based on its analysis. In another embodiment, ROCC engine 110 sets a deadband and a time limit on each transmitter (e.g., pressure transmitter, flow transmitter, etc.) of the pipeline and calls this a rate of change (ROC) item, and allows an end user to define combinations of ROC items (e.g., ((A && B)∥C); (C∥E); (D && A && B), etc.). These ROCs are applied alone or in tandem with thresholds for other equipment to create more selective indications of a disturbance in the pipeline that might signal a severe loss of commodity has occurred, in an aspect.

A singular rate of change alarm/item (e.g. ROC) is defined by tying a threshold value for the rate at which a given transmitter's output can change to a given transmitter. In an embodiment, ROCC engine 110 uses a filter (e.g., a Savitsky-Golay filter, described further herein) to compute instantaneous derivatives, which avoids the need for defining both a magnitude and a time period. The ROCC engine 110 assigns a name to an ROC (e.g., “A”, “B”, “C”, etc.) along with a transmitter that it will monitor and a threshold value for the maximum that the derivative can change before the ROC alarms, in accordance with an aspect of the disclosure. As described above, ROCC engine 110 analyzes, in addition to individual transmitters whose values are changing too quickly, logical combinations of transmitters whose values are changing in conjunction with one another too quickly to reduce false alarms. In an embodiment, ROCC engine 110 enables an end user to define logical combinations of ROCs using Boolean operations (e.g., AND, OR, etc.).

When a combination of transmitters that have exceeded the rate of change threshold value evaluate to TRUE, ROCC engine 110 transmits a positive rupture status determination to neural network combiner 112. For example, a user may define the following ROCCs: (A & B)|C; (A|B) & C; A & B & C. The ROCC engine 110 would generate an alarm status determination when the logical combination of the trio evaluates to TRUE. In the first case, ROCC engine 110 generates an alarm status determination when ROCs “A” and “B” both evaluated to TRUE, or when ROC “C” is true. In the second case, ROCC engine 110 generates an alarm status determination when “A” or “B” are TRUE and “C” is TRUE. In the third case, ROCC engine 110 generates an alarm status determination when all three ROCs are TRUE. In an embodiment, the status determination generated by ROCC engine 110 is binary (e.g., YES/NO, TRUE/FALSE, etc.). Additional details of ROCC engine 110 are further described herein.

The neural network combiner 112 is configured to receive and analyze status determinations from each independent rupture detection technique (e.g., support vector machine 106, third-law engine 108, ROCC engine 110, etc.) and generate a single final status determination indicative of whether the pipeline is ruptured in real-time during an online operation. In an embodiment, neural network combiner 112 utilizes a neural network algorithm to analyze the status determinations independently generated by each rupture detection technique. A number of suitable neural network algorithms exist and are known by those having ordinary skill in the art. In accordance with an aspect of the disclosure, neural network combiner 112 enables system and process 100 to generate a single, higher-confidence final status determination indicative of whether the pipeline is ruptured than what a single known technique can provide. Additional details of training neural network combiner 112 are further described herein. In an embodiment, display device 116 (e.g., a PC monitor, a touchscreen of a smartphone or tablet computing device, etc.) displays the single final status determination generated by neural network combiner 112.

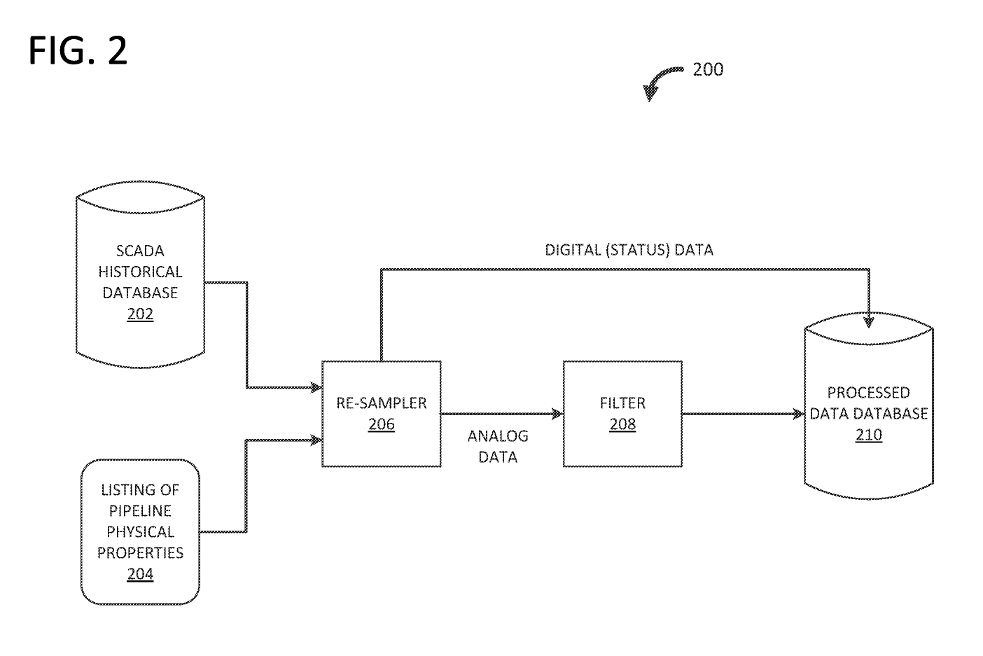

FIG. 2 illustrates an exemplary embodiment of a historical data processing engine and a method performed thereby, generally indicated at 200, configured to format historical pipeline data from input data source 102 for training support vector machine 106 and neural network combiner 112. In this embodiment, the historical data processing engine 200 includes a SCADA historical database 202, a listing of pipeline physical properties 204, a re-sampler 206, a filter 208, and a processed data database 210. In an embodiment, the SCADA historical database 202 includes data representing previous pipeline operating conditions (e.g., from a predetermined number of prior years). The listing of pipeline physical properties 204 includes a complete list of all pressure and flow transmitters, control valve positions, valve statuses, pump statuses, VFD settings (if appropriate), and the like for the pipeline, in accordance with an embodiment of the disclosure.

The historical data processing engine 200 passes raw data from SCADA historical database 202 through the re-sampler 206, which samples the data (e.g., both analog data and status (digital) data) with a predetermined level hold function to get values over a predetermined time period (e.g., every five seconds, etc.). The data representing status signals are directly stored in the processed data database 210. In this manner, data representing status signals is filtered with a zeroth order hold function.

The historical data processing engine 200 passes the analog data (e.g., representing transmitter values) through the filter 208, which smooths the data and computes the first and second derivatives of the signal. In an embodiment, filter 208 is a Savitsky-Golay filter that, when given a raw data set, yᵢ, returns a smoothed data set, Yᵢ. An exemplary Savitsky-Golay filter is described by Equations (1)-(4) below. The historical data processing engine 200 places the filtered data into processed data database 210 to be used for future processing by the pipeline rupture detection system and process 100 (e.g., online processing).

$$\begin{matrix}{Y}_{j}^{( k )} = {\sum }_{i = - ( m - 1 ) / 2}^{( m - 1 ) / 2} {C}_{ki} {y}_{j + 1} \frac{m + 1}{2} \leq j \leq n - \frac{m - 1}{2} & Equation ( 1 ) \\ {C}_{0 i} = \frac{( 3 {m}^{2} - 7 - 20 {i}^{2} ) / 4}{m ( {m}^{2} - 4 ) / 3} \frac{1 - m}{2} \leq i \leq \frac{m - 1}{2} & Equation ( 2 ) \\ {C}_{1 i} = \frac{5 ( 3 {m}^{4} - 18 {m}^{2} + 31 ) i - 28 ( 3 {m}^{2} - 7 ) {i}^{3}}{m ( {m}^{2} - 1 ) ( 3 {m}^{4} - 39 {m}^{2} + 108 ) / 15} & Equation ( 3 ) \\ {C}_{2 i} = \frac{12 m {i}^{2} - m ( {m}^{2} - 1 )}{{m}^{2} ( {m}^{2} - 1 ) ( {m}^{2} - 4 ) / 15} & Equation ( 4 )\end{matrix}$$

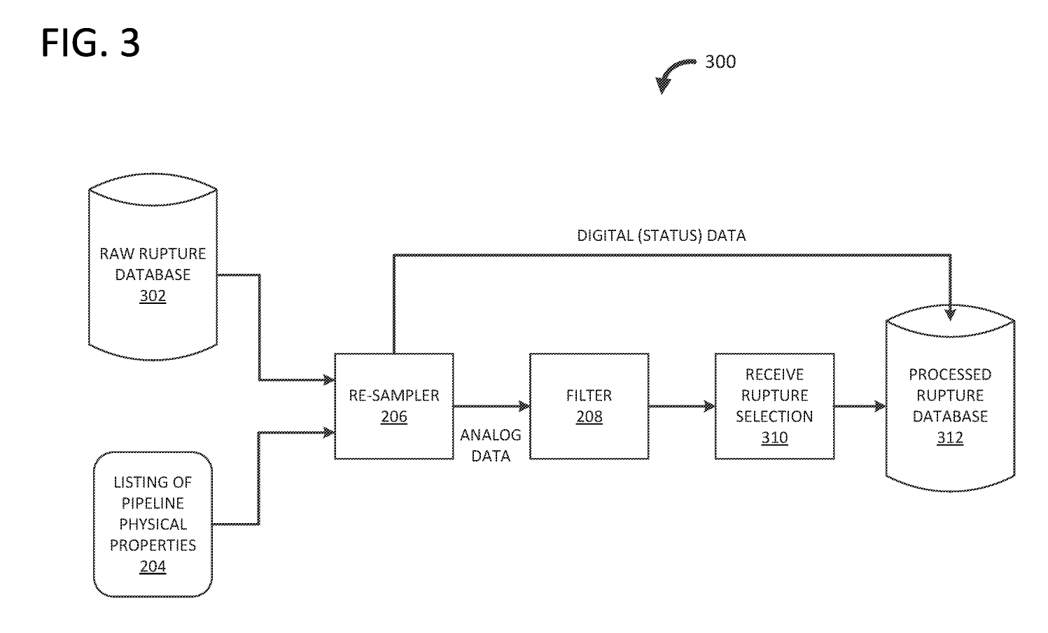

FIG. 3 illustrates an exemplary embodiment of a historical data processing engine and a method performed thereby, generally indicated at 300, configured to format data representative of a rupture of the pipeline for training support vector machine 106 and neural network combiner 112. In this embodiment, historical data processing engine 104 includes a raw rupture database 302, the listing of pipeline physical properties 204, the re-sampler 206, the filter 208, and a processed rupture database 312. In an embodiment, raw rupture database 302 includes specific data representative of one or more real-world ruptures of the pipeline. Additionally or alternatively, raw rupture database 302 includes data representative of one or more simulated pipeline ruptures. The historical data processing engine 300 passes raw data from raw rupture database 302 through the re-sampler 206, which samples the data with a predetermined level hold function to get values over a predetermined time period, as described above.

The historical data processing engine 300 passes the analog data through the filter 208, which smooths the data and computes the first and second derivatives, as described above. The filtered data is then presented, at step 310, to a user who selects the window of data that is “most rupture like.” In an embodiment, aspects of the present disclosure utilize five-minute data windows and the user (e.g., engineer) selects the five-minute window from the filtered data that best represents a pipeline rupture. The historical data processing engine 300 then places data from the selected window of time into processed rupture database 312 to be used for future processing by the pipeline rupture detection system and process 100 (e.g., online processing).

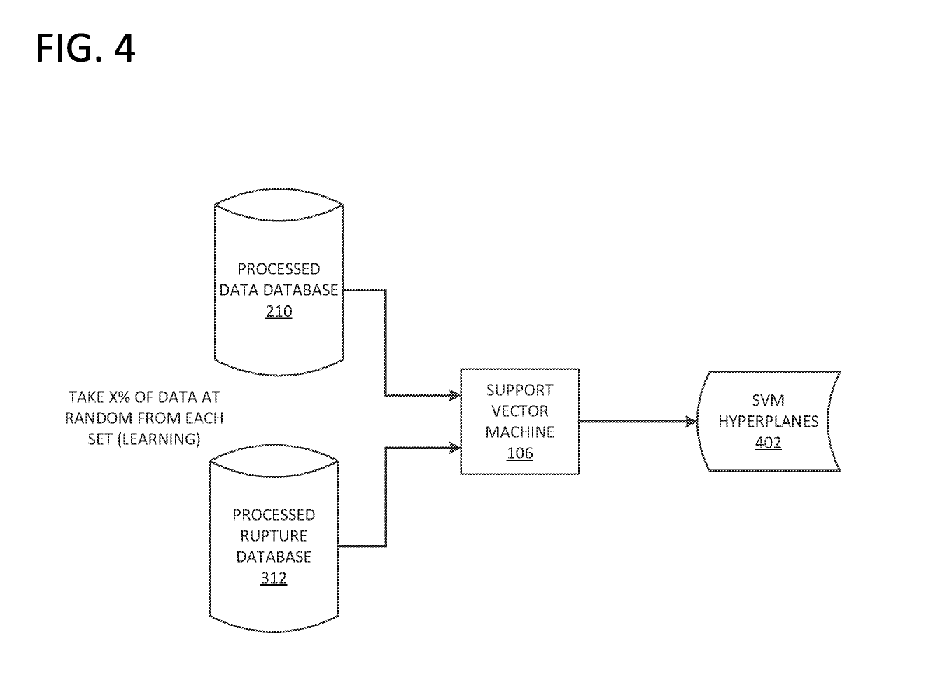

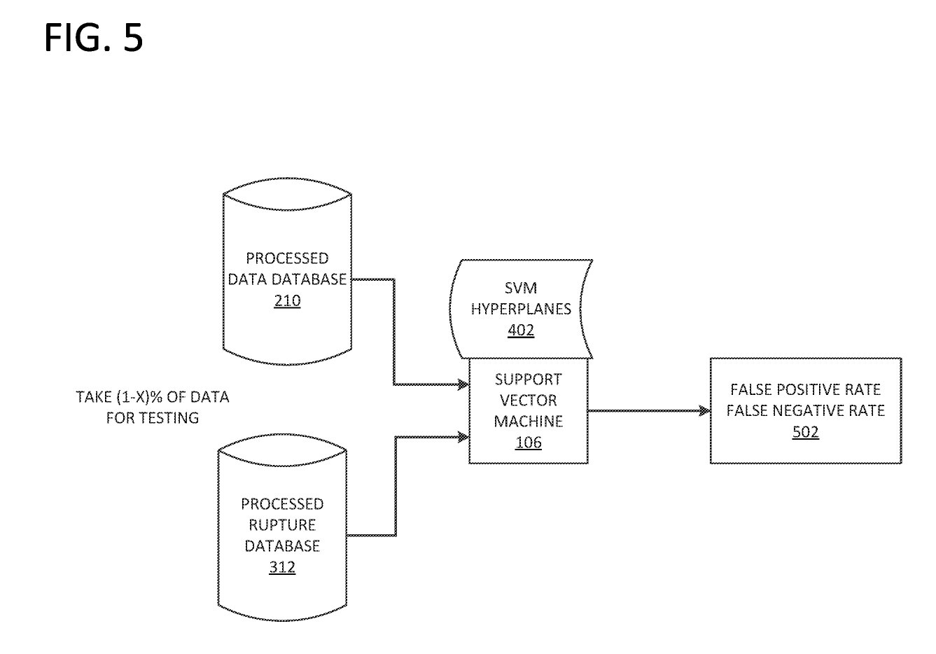

FIGS. 4 and 5 illustrate exemplary supervised learning methods of support vector machine 106. In an embodiment of an offline training mode, support vector machine 106 is fed training data, which it uses to create a hyperplane that best separates two classes of data. Referring to FIG. 4, support vector machine 106 selects, at random, a predetermined percentage of data (e.g., X %) from each of processed data database 210 and processed rupture database 312 to become a learning dataset. The learning dataset is fed into support vector machine 106 along with information about whether the data is a normal condition or a rupture (e.g., abnormal) condition. The output is a collection of parameters defining one or more hyperplanes 402 that separate the data representing a normal condition from the data representing a rupture condition. Referring to FIG. 5, the remaining percentage of data (e.g., (1-X) %) is used to test the applicability of the generated hyperplane. The remaining data is fed into support vector machine 106 utilizing the hyperplane 402 to generate a set of false positives (i.e., conditions classified as ruptures that are not) and false negatives (i.e., ruptures that are classified as normal operating conditions).

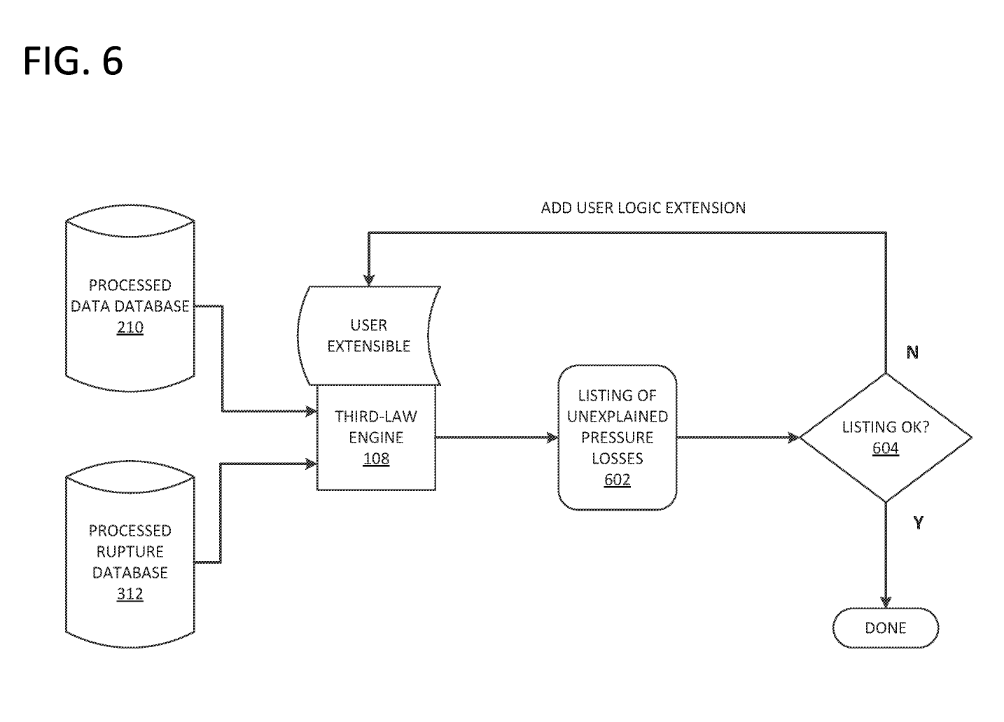

FIG. 6 illustrates an exemplary offline testing method of third-law engine 108. The third-law engine 108 is fed data from processed data database 210 and processed rupture database 312 (e.g., a series of pressure transmitters and their respective locations and a series of control surfaces and their respective locations, etc.). When third-law engine 108 identifies a pressure drop at one transmitter, it looks upstream and/or downstream to determine whether a control surface changed at an appropriate time in the past to explain causation of the pressure drop. For example, third-law engine 108 utilizes the relationship between distance, speed of sound, and time (i.e., distance=speed of sound*time) in the analysis. When third-law engine 108 determines the pressure drop was not caused by a corresponding control surface change, then third-law engine 108 generates, at step 602, a listing of unexplained pressure losses. When the listing is satisfactory, as determined at step 604, the process ends. In an embodiment, this is determined by a user (e.g., customer, rupture detection engineer, etc.) on a case-by-case basis. For example, the user may specify that X number of false alarms per Y time is satisfactory. When the listing is unsatisfactory, as determined at step 604, the process adds user logic extensions and repeats.

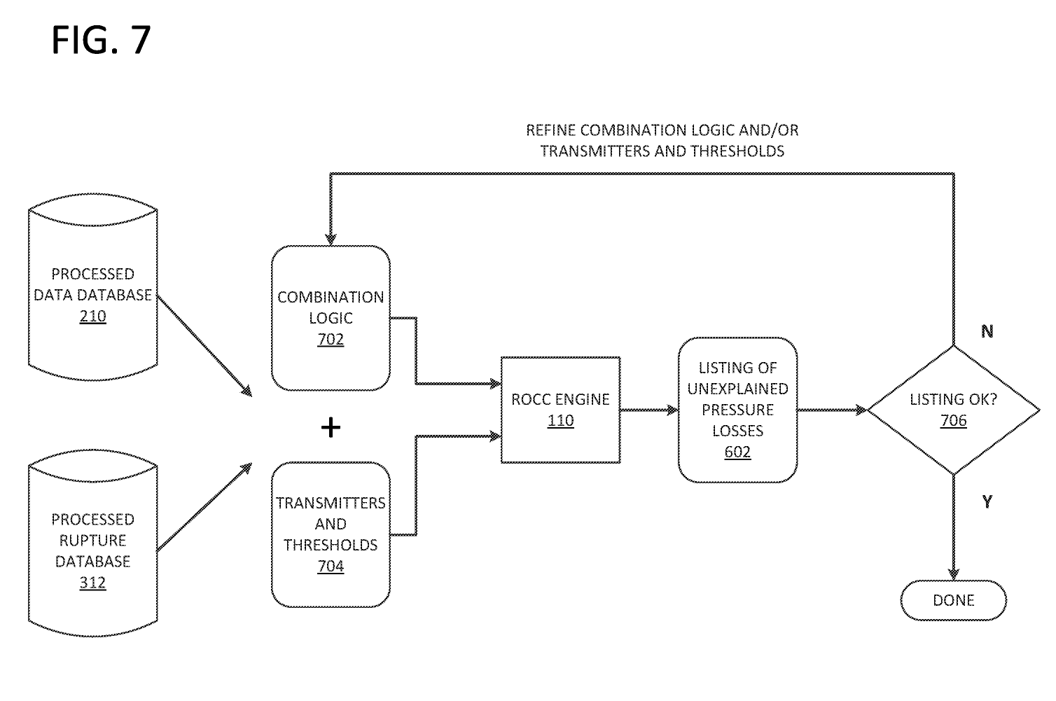

FIG. 7 illustrates an exemplary offline method of setting up ROCC engine 110. Combination logic 702 and transmitters and thresholds 704 are used to refine data from processed data database 210 and processed rupture database 312 and feed it to ROCC engine 110. In an embodiment, one or more window input forms displayed on a display device via a graphical user interface enable an end-user to define an ROC item (i.e., a transmitter and a rate of change threshold) and a second window that enables the end-user to specify a set of logical combinations of ROC items, as further described herein. Each transmitter, such as pressure transmitters (e.g., P1, P2, etc.), flow transmitters (e.g., F1, F2, etc.), and the like, can be defined as an ROC item by specifying the transmitter name and a rate of change threshold (e.g., A=P1: 100 kPa/min, B=F2: 50 bbls/hr/hr, etc.). Then the end-user may specify an ROCC combination group by listing logical combinations of previously defined ROC items, as further described herein. The ROCC engine 110 evaluates each ROC item and then each ROCC logical combination at each pass to determine whether any combinations evaluate to TRUE. When the listing is satisfactory, as determined at step 706, the process ends. When the listing is unsatisfactory, as determined at step 706, the process refines the combination logic 702 and/or transmitters and thresholds 704 and repeats. For example, if an undesirable level of false alarms are generated, they may be reduced by generating more ROC items to capture more inputs, widening the threshold on any given ROC item, adding more logic combinations of ROC items into ROCC engine 110, and/or combinations thereof.

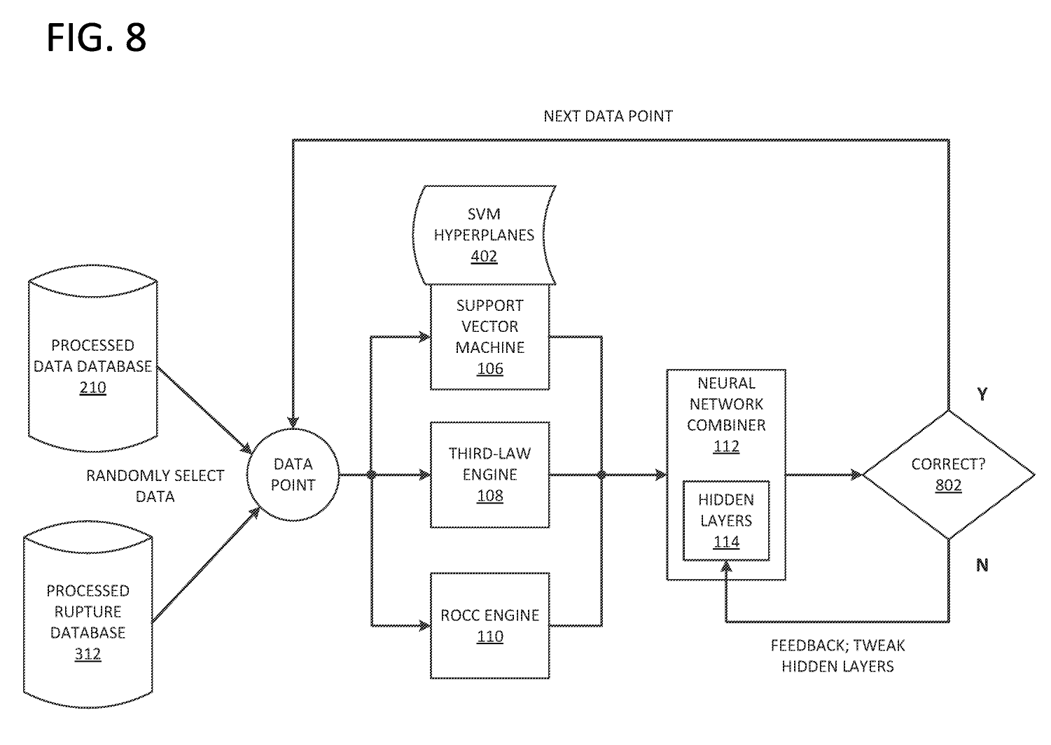

FIG. 8 illustrates an exemplary offline method of training neural network combiner 112. A data point is randomly selected from either processed data database 210 or processed rupture database 312 and tagged as either indicative of a pipeline rupture or indicative of a normal pipeline operating condition (i.e., no rupture). The tagged data point is independently analyzed by trained support vector machine 106 (e.g., including hyperplanes 402), third-law engine 108, and ROCC engine 110, each of which independently generates a status determination indicative of whether the pipeline is ruptured. The status determinations are analyzed by neural network combiner 112, which generates a final status determination indicative of whether the pipeline is ruptured. The generated final status determination is compared to the correct answer (e.g., the tag of whether the data point is indicative of a rupture or no rupture) at step 802. When the final status determination generated by neural network combiner 112 is correct, the process advances to the next data point. When the final status determination generated by neural network combiner 112 is incorrect, hidden layers are tweaked (e.g., specify the number of intermediate hidden layers and/or how many nodes they each have, etc.) to train neural network combiner 112.

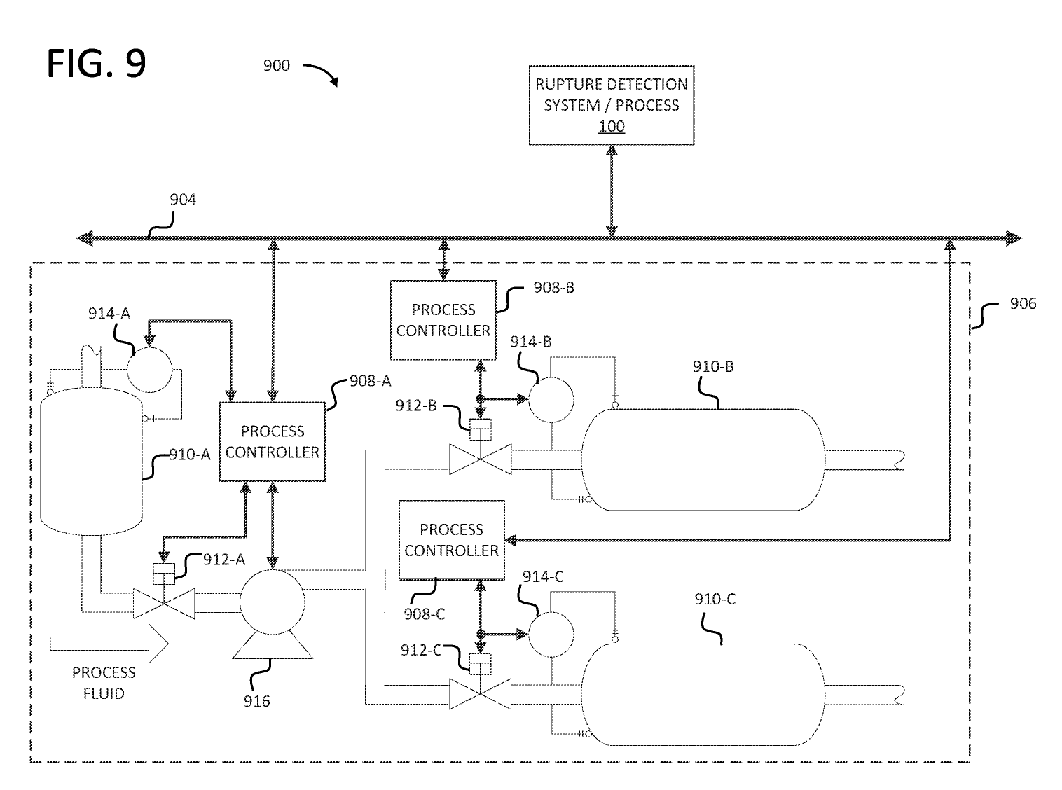

FIG. 9 illustrates an exemplary system, generally indicated at 900, within which an embodiment of the disclosure may be incorporated. The system 900 includes the pipeline rupture detection system and process 100, a communications infrastructure 904, and an exemplary plant, such as a fluid processing system 906. As illustrated, the fluid processing system 906 includes process controllers 908, tanks 910, valves 912, sensors 914, and a pump 916. In an embodiment, the system and process 100, the communications infrastructure 904, the process controllers 908, and the sensors 914 comprise a supervisory control and data acquisition (SCADA) system. In system 900, system and process 100, process controllers 908, the tanks 910, the valves 912, sensors 914, and the pump 916 are communicatively coupled via communications infrastructure 904.

The communications infrastructure 904 is capable of facilitating the exchange of data among various components of system 900, including system and process 100 and components of fluid processing system 906 (e.g., process controllers 908, valves 912, sensors 914, etc.). The communications infrastructure 904 in the embodiment of FIG. 9 includes a local area network (LAN) that is connectable to other telecommunications networks, including other LANs or portions of the Internet or an intranet. The communications infrastructure 904 may be any telecommunications network that facilitates the exchange of data, such as those that operate according to the IEEE 802.3 (e.g., Ethernet) and/or the IEEE 802.11 (e.g., Wi-Fi) protocols, for example. In another embodiment, communications infrastructure 904 is any medium that allows data to be physically transferred through serial or parallel communication channels (e.g., copper wire, optical fiber, computer bus, wireless communication channel, etc.). In an embodiment, communications infrastructure 904 comprises at least in part a process control network. In another embodiment, communications infrastructure 904 comprises at least in part a SCADA system.

Still referring to FIG. 9, the fluid processing system 906 is adapted for changing or refining raw materials to create end products. It will be apparent to one skilled in the art that aspects of the present disclosure are capable of optimizing processes and processing systems other than fluid processing system 906 and that system 906 is presented for illustration purposes only. Additional exemplary processes include, but are not limited to, those in the chemical, oil and gas, food and beverage, pharmaceutical, water treatment, and electrical power industries. For example, processes may include conveyers, power distribution systems, and/or processes or operations that cannot be interrupted. In an embodiment, process controllers 908 provide an interface or gateway between components of fluid processing system 906 (e.g., valves 912, sensors 914, pump 916) and other components of system 900. In another embodiment, components of fluid processing system 906 communicate directly with system and process 100 via communications infrastructure 904. In yet another embodiment, process controllers 908 transmit data to and receive data from system and process 100, valves 912, sensors 914, and/or pump 916 for controlling and/or monitoring various aspects of fluid processing system 906.

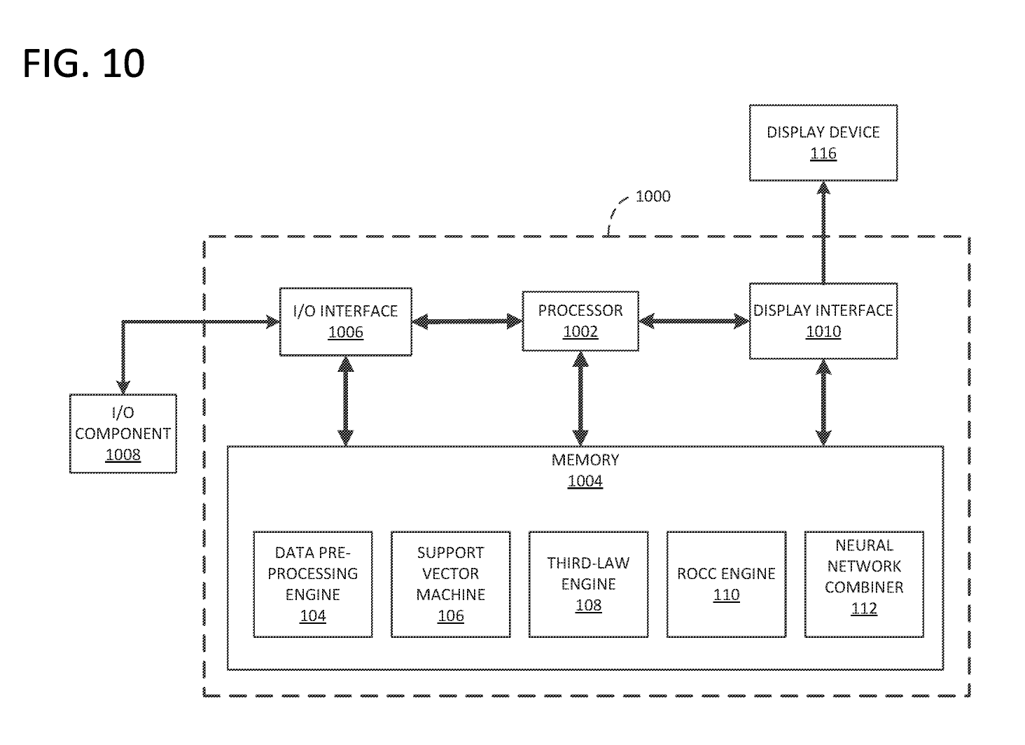

The process controllers 908 of FIG. 10 are adapted to control and/or monitor aspects of fluid processing system 906. In an embodiment, processor controllers 908 are programmable logic controllers (PLC) that control and collect data from aspects of fluid processing system 906. In another embodiment, process controllers 908 are adapted to execute real-time applications that receive configuration data values and real-time data values from system and process 100, as further described herein.

FIG. 10 illustrates an exemplary architecture of a computing device 1000 (e.g., mobile computing device, tablet computing device, desktop computing device, smartphone, etc.) programmed to provide aspects of the systems and processes described herein via a software environment. In this embodiment, the computing device 1000 includes a processor 1002, a memory 1004, an input/output (I/O) interface 1006 that interfaces with an I/O component 1008, and display interface 1010. The memory 1004 includes pre-processing engine 104, support vector machine 106, third-law engine 108, ROCC engine 110, and neural network combiner 112 each embodied in processor-executable instructions for executing by processor 1002. In this manner, the computing device 1000 comprises a special-purpose computing device for detecting pipeline ruptures and generating a graphical display indicating the status of the pipeline (e.g., “rupture” or “no rupture”) on display device 116 in accordance with an aspect of the disclosure.

The processor 1002, memory 1004, I/O interface 1006, and display interface 1010 are communicatively connected and/or electrically connected to each other. The I/O interface 1006 is communicatively and/or electrically connected to the I/O component 1008. The processor 1002 is adapted to execute processor-executable instructions stored in the memory 1004 for retrieving data from input data source 102, analyzing the data, and generating graphical displays on display device 116 in real time. The I/O interface 1006 of FIG. 10 provides a physical data connection between the computing device 1000 and I/O component 1008. In an embodiment, I/O interface 1006 is a network interface card (NIC) or modem and I/O component 1008 is a telecommunications network (e.g., communications network 904). The display interface 1010 provides a physical data connection between computing device 1000 and display device 116. In an embodiment, display device 116 is a touchscreen of a smartphone, tablet computing device, or the like.

In an embodiment, pipeline rupture detection system 100 includes display device 116, processor 1002, and at least one computer-readable storage medium (e.g., memory 1004) storing one or more processor-executable instructions. Included in the instructions are support vector machine 106, third-law engine 108, ROCC engine 110, and neural network combiner 112. The support vector machine 106 is configured to analyze input data from input data source 102 with a supervised machine learning algorithm and generate a first status determination indicative of whether the pipeline is ruptured based on the analysis. The input data represents one or more physical properties of the pipeline. The third-law engine 108 is configured to analyze the input data for pressure changes in the pipeline relative to operating state changes of the pipeline represented by the input data. Based on the analysis, third-law engine 108 is configured to generate a second status determination indicative of whether the pipeline is ruptured. The ROCC engine 110 is configured to analyze the input data for changes to the physical properties of the pipeline occurring at rates that exceed predetermined physical limits of the pipeline and generate a third status determination indicative of whether the pipeline is ruptured based on the analysis. The neural network combiner 112 is configured to execute a neural network algorithm on the first status determination, the second status determination, and the third status determination. Based on this analysis, neural network combiner 112 generates a final status determination on display device 116 indicative of whether the pipeline is ruptured.

In another embodiment, a computer-implemented method for detecting pipeline ruptures with high confidence includes receiving pipeline data from input data source 102 in the form of a SCADA system. The pipeline data represents a physical state of a pipeline. The support vector machine 106 generates a first status determination indicative of whether the pipeline is ruptured by analyzing the pipeline data with a supervised machine learning algorithm. The third-law engine 108 generates a second status determination indicative of whether the pipeline is ruptured by comparing pressure changes in the pipeline to operating state changes of the pipeline. The ROCC engine 110 generates a third status determination indicative of whether the pipeline is ruptured by analyzing the pipeline data for changes to the physical properties occurring at rates that predetermined exceed physical limits of the pipeline. The neural network combiner 112 then generates a final status determination on display device 116 that is indicative of whether the pipeline is ruptured. The neural network combiner 112 generates the determination by analyzing the first, second, and third status determinations with a neural network algorithm.

In yet another embodiment, a computer readable storage device (e.g., memory 1004) stores processor readable instructions that, when executed by processor 1002, implement a method of automatically detecting pipeline ruptures. The method includes receiving pipeline data from a SCADA system (e.g., input data source 102) that represents physical properties of a pipeline. The support vector machine 106 generates a first status determination indicative of whether the pipeline is ruptured by analyzing the pipeline data with a supervised machine learning algorithm. The third-law engine 108 generates a second status determination indicative of whether the pipeline is ruptured by comparing pressure changes in the pipeline to operating state changes of the pipeline. The ROCC engine 110 generates a third status determination indicative of whether the pipeline is ruptured by analyzing the pipeline data for changes to the physical properties occurring at rates that exceed predetermined physical limits of the pipeline. The neural network combiner 112 generates a final status determination on display device 116 that is indicative of whether the pipeline is ruptured. The neural network combiner 112 generates the determination by analyzing the first, second, and third status determinations with a neural network algorithm.

In an aspect, the pipeline rupture techniques described herein are distinct from pipeline leak detection techniques. For example, leak detection techniques focus on detecting the smallest leak in the shortest possible amount of time with an inherent allowance for false alarms. In contrast, the pipeline rupture techniques described herein provide a highly certain (e.g., false rupture alarm once per decade, once per pipeline per year, etc.) indication of a large volume and/or high rate commodity release from the pipeline, in an embodiment. One of ordinary skill in the art will understand that no globally accepted definition exists of what constitutes a rupture. But, as used herein in one or more embodiments, a rupture includes a leak of greater than 50% rated flow (or other threshold), a rapid bursting open of a container such as a segment of pipeline, a complete failure of any portion of a pipeline, and/or combinations thereof.

In addition to the embodiments described above, embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer. By way of example, and not limitation, computer-readable storage media include both volatile and nonvolatile, removable and non-removable media implemented in any method or technology for storage of information such as computer readable instructions, data structures, program modules or other data. Computer storage media are non-transitory and include, but are not limited to, random access memory (RAM), read only memory (ROM), electrically erasable programmable ROM (EEPROM), compact disk ROM (CD-ROM), digital versatile disks (DVD), or other optical disk storage, solid state drives (SSDs), magnetic cassettes, magnetic tape, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes nonvolatile and volatile memory types. A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, SSDs, and the like.

Communication media typically embody computer readable instructions, data structures, program modules or other data in a modulated data signal such as a carrier wave or other transport mechanism and includes any information delivery media.

One or more aspects of the disclosure may be embodied in computer-executable instructions (i.e., software), routines, or functions stored in system memory or nonvolatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A pipeline rupture detection system, comprising:
a display device;
at least one processor; and
at least one computer-readable storage medium storing one or more processor-executable instructions, said processor-executable instructions including instructions comprising:
a support vector machine configured to analyze input data with a supervised machine learning algorithm, and generate a first status determination indicative of whether a pipeline is ruptured based on said analysis, wherein the input data represents one or more physical properties of the pipeline;
a third-law engine configured to analyze the input data for pressure changes in the pipeline represented by the input data relative to operating state changes of the pipeline represented by the input data, and generate a second status determination indicative of whether the pipeline is ruptured based on said analysis;
a rate of change combination engine configured to analyze the input data for changes to the one or more physical properties occurring at rates that exceed predetermined physical limits of the pipeline, and generate a third status determination indicative of whether the pipeline is ruptured based on said analysis; and
a neural network combiner configured to execute a neural network algorithm on the first status determination, the second status determination, and the third status determination, in response to said generation thereof, and to generate a final status determination on the display device indicative of whether the pipeline is ruptured based on said execution.

2. The pipeline rupture detection system of claim 1, said processor-executable instructions further including instructions comprising a historical data trainer configured to train the support vector machine and the neural network combiner with historical data representing one or more measurable historical physical properties of the pipeline.

3. The pipeline rupture detection system of claim 2, wherein the historical data trainer trains the support vector machine with a set of normal operating conditions of the pipeline and a set of abnormal operating conditions of the pipeline.

4. The pipeline rupture detection system of claim 2, wherein the historical data trainer trains the neural network combiner with status determinations generated by one or more of the support vector machine, the third-law engine, and the rate of change combination engine based on analyses thereby of tagged data, wherein the tagged data is indicative of whether the pipeline is ruptured.

5. The pipeline rupture detection system of claim 1, wherein the support vector machine, the third-law engine, and the rate of change combination engine generate their respective status determinations independently of each other.

6. The pipeline rupture detection system of claim 1, wherein the third-law engine assumes pressure in the pipeline remains unchanged in the absence of operating state changes of the pipeline.

7. The pipeline rupture detection system of claim 1, wherein the support vector machine, the third-law engine, and the rate of change combination engine each receive the input data from a supervisory control and data acquisition system configured to monitor the physical properties of the pipeline.

8. A computer-implemented method for detecting pipeline ruptures with high confidence, comprising:
receiving pipeline data from a supervisory control and data acquisition system, the pipeline data representing one or more physical properties of a pipeline;
generating, by a support vector machine, a first status determination indicative of whether the pipeline is ruptured by analyzing the pipeline data with a supervised machine learning algorithm, wherein the support vector machine comprises one or more processor-executable instructions executed by at least one processor;
generating, by a third-law engine, a second status determination indicative of whether the pipeline is ruptured by comparing pressure changes in the pipeline represented by the pipeline data to operating state changes of the pipeline represented by the pipeline data, wherein the third-law engine comprises one or more processor-executable instructions executed by the at least one processor;
generating, by a rate of change combination engine, a third status determination indicative of whether the pipeline is ruptured by analyzing the pipeline data for changes to the one or more physical properties occurring at rates that exceed predetermined physical limits of the pipeline, wherein the rate of change combination engine comprises one or more processor-executable instructions executed by the at least one processor; and
generating, by a neural network combiner, a final status determination on a display device indicative of whether the pipeline is ruptured by analyzing the first status determination, the second status determination, and the third status determination, in response to the generation thereof, with a neural network algorithm.

9. The method of claim 8, further comprising ceasing a flow of fluid through the pipeline when the final status determination is indicative of the pipeline being ruptured by at least one of closing a valve of the pipeline and turning off a pump of the pipeline.

10. The method of claim 8, further comprising training, by a historical data trainer, the support vector machine and the neural network combiner with historical data representing measurable historical physical properties of the pipeline, wherein the historical data trainer comprises one or more processor-executable instructions executed by the at least one processor.

11. The method of claim 10, wherein the historical data trainer trains the support vector machine with a set of normal operating conditions of the pipeline and a set of abnormal operating conditions of the pipeline.

12. The method of claim 10, wherein the historical data trainer trains the neural network combiner with status determinations generated by one or more of the support vector machine, the third-law engine, and the rate of change combination engine based on analyses thereby of tagged data, wherein the tagged data is indicative of whether the pipeline is ruptured.

13. The method of claim 8, wherein the support vector machine, the third-law engine, and the rate of change combination engine independently perform said generating the first status determination, said generating the second status determination, and said generating the third status determination, respectively.

14. The method of claim 8, wherein the third-law engine assumes pressure in the pipeline remains unchanged in the absence of operating state changes of the pipeline.

15. A computer readable storage device having processor readable instructions stored thereon including instructions that, when executed by a processor, implement a method of automatically detecting pipeline ruptures, comprising:
receiving pipeline data from a supervisory control and data acquisition system, the pipeline data representing one or more physical properties of a pipeline;
generating, by a support vector machine, a first status determination indicative of whether the pipeline is ruptured by analyzing the pipeline data with a supervised machine learning algorithm, wherein the support vector machine comprises one or more processor-executable instructions executed by at least one processor;
generating, by a third-law engine, a second status determination indicative of whether the pipeline is ruptured by comparing pressure changes in the pipeline represented by the pipeline data to operating state changes of the pipeline represented by the pipeline data, wherein the third-law engine comprises one or more processor-executable instructions executed by the at least one processor;
generating, by a rate of change combination engine, a third status determination indicative of whether the pipeline is ruptured by analyzing the pipeline data for changes to the one or more physical properties occurring at rates that exceed predetermined physical limits of the pipeline, wherein the rate of change combination engine comprises one or more processor-executable instructions executed by the at least one processor; and
generating, by a neural network combiner, a final status determination on a display device indicative of whether the pipeline is ruptured by analyzing the first status determination, the second status determination, and the third status determination, in response to the generation thereof, with a neural network algorithm.

16. The computer readable storage device of claim 15, further comprising ceasing a flow of fluid through the pipeline when the final status determination is indicative of the pipeline being ruptured by at least one of closing a valve of the pipeline and turning off a pump of the pipeline.

17. The computer readable storage device of claim 15, further comprising training, by a historical data trainer, the support vector machine and the neural network combiner with historical data representing the one or more measurable physical properties of the pipeline, wherein the historical data trainer comprises one or more processor-executable instructions executed by the at least one processor.

18. The computer readable storage device of claim 17, wherein the historical data trainer trains the support vector machine with a set of normal operating conditions of the pipeline and a set of abnormal operating conditions of the pipeline.

19. The computer readable storage device of claim 17, wherein the historical data trainer trains the neural network combiner with status determinations generated by the support vector machine, the third-law engine, and the rate of change combination engine based on analyses thereby of tagged data, wherein the tagged data is indicative of whether the pipeline is ruptured.

20. The computer readable storage device of claim 15, wherein the support vector machine, the third-law engine, and the rate of change combination engine independently perform said generating the first status determination, said generating the second status determination, and said generating the third status determination, respectively.
